(19) United States
(12) Patent Application Publication
(10) Pub. No.: US 2008/0093776 A1
(43) Pub. Date: Apr. 24, 2008

(54) METHOD OF MOLDING ULTRAVIOLET CURED MICROSTRUCTURES AND MOLDS

(75) Inventor: Todd R. Williams, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/538,933

(22) Filed: Oct. 5, 2006

(51) Int. Cl. B29C 35/08; B29C 41/12

(52) U.S. Cl. 264/496; 264/319; 425/174.2; 425/385

(57) ABSTRACT

Presently described is a microstructured mold prepared from a photocured polymeric material that comprises at least one (i.e. first) photoinitiator having certain absorption characteristics. The mold is suitable for use in methods of molding a (e.g. barrier rib) microstructure precursor composition that comprises at least one (i.e. second) photoinitiator. The second photoinitiator of the microstructure precursor preferably has similar absorptions characteristics as the first photoinitiator. Thus, the polymeric material of the mold the microstructure precursor can be cured with the same wavelength range of light.

### BACKGROUND OF THE INVENTION

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which barrier ribs can be formed on glass substrates is by direct molding. This has involved laminating a mold onto a substrate with a glass- or ceramic-forming composition disposed therebetween. Suitable compositions are described for example in U.S. Pat. No. 6,352,763. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

U.S. Pat. No. 6,843,952 describes a method of producing a substrate for a plasma display panel by providing a rib on a base, which comprises the steps of contacting a rib precursor containing a first photo-setting initiator having a first absorption edge and a first photo-setting component closely with said base; filling a mold with the rib precursor, wherein the mold is obtained by photo-setting of a second photo-setting initiator having a second absorption edge whose wavelength is shorter than a wavelength corresponding to said first absorption edge of said first photo-setting initiator; exposing said rib precursor to light having a wavelength longer than a wavelength corresponding to said second absorption edge, thereby setting said rib precursor; and removing said mold. In one embodiment, the first photo-setting initiator (i.e. of the rib precursor) has a first adsorption edge corresponding to a wavelength of 400 to 500 nm and the second photo-setting initiator (i.e. of the mold) has a second absorption edge corresponding to a wavelength of 300 to 400 nm.

### SUMMARY OF THE INVENTION

Methods of making (e.g. barrier rib) microstructures are described.

In one embodiment, the method comprises providing a mold having a microstructured surface comprising recesses (e.g. suitable for making barrier ribs) wherein at least the microstructured surface comprises a photocured polymeric material comprising a first photoinitiator having an absorption coefficient of at least 100 at a wavelength ranging from about 385 nm to about 465 nm; filling the recesses of the mold with a photocurable microstructure precursor; photocuring the microstructure precursor; and removing the mold from the cured (e.g. barrier rib) microstructures. The first and/or second photoinitiator is preferably selected from acyl phosphine oxide, α-aminoketone, and mixtures thereof.

In another embodiment, the method comprises providing a mold having a microstructured surface comprising recesses wherein at least the microstructured surface comprises a photocured polymeric material having a first photoinitiator selected from acyl phosphine oxide, α-amino ketone, and mixtures thereof, filling the recesses of the mold with a photocurable microstructure precursor comprising a second photoinitiator selected from acyl phosphine oxide, α-amino ketone, and mixtures thereof, photocuring the microstructure precursor; and removing the mold.

In yet another embodiment, the method comprises providing a mold having a microstructured surface comprising recesses wherein at least the microstructured surface comprises a polymeric material photocured at a wavelength ranging from about 385 nm to 465 nm; filling the recesses of the mold with a microstructure precursor composition comprising a second photoinitiator; photocuring the microstructure precursor composition at a wavelength range that includes at least a portion of the wavelength range used to cure the photocured polymeric material of the mold; and removing the mold from the cured microstructures without breakage of the microstructures.

In the method of making barrier ribs describe herein, the microstructure precursor is preferably contacted with a substrate prior to curing of the precursor. The substrate is generally a glass substrate having an electrode pattern and the microstructured surface of the mold is aligned with the electrode pattern. The microstructure precursor may be cured though the mold, through, the substrate, or a combination thereof.

The second photoinitiator preferably has an absorption coefficient of at least 100 at a wavelength ranging from about 385 nm to about 465 nm. The photocuring light for curing the photocurable polymeric material of the mold and/or the microstructure precursor can be provided by super actinic bulbs.

In another embodiment, a mold is described having a microstructured surface comprising recesses wherein the microstructure surface comprises a photocured polymeric material comprising a photoinitiator having an absorption coefficient of at least 100 at a wavelength ranging from about 385 nm to about 465 nm. The mold may further comprise a light transmissible support such as a polyester film.

### BRIEF DESCRIPTION OF THE DRAWINGS

FIG. 1 is a perspective view of an illustrative flexible mold suitable for making barrier ribs.

FIG. 2A-2C is a section view, in sequence of an illustrative method of making a fine structure (e.g. barrier ribs) by use of a flexible mold.

FIG. 3 is a graph depicting the absorption coefficient of various photoinitiators.

### DETAILED DESCRIPTION OF THE PREFERRED EMBODIMENTS

The present invention relates to molds having a photopolymerized polymeric molding surface and methods of making microstructures (e.g. barrier ribs), and intermediate (e.g. display) articles prepared during the method. Hereinafter, the embodiments of the invention will be explained with reference to method of making barrier rib microstructures with a (e.g. flexible) polymeric mold. The curable compositions can be utilized with other (e.g. microstructured) devices and articles such as for example, electrophoresis plates with capillary channels and lighting applications. In particular, devices and articles that can utilize molded glass- or ceramic-microstructures can be formed using the methods described herein. While the present invention is not so limited, an appreciation of various aspects of the invention will be gained through a discussion of methods, apparatus and articles for the manufacture of barrier ribs for PDPs.

The recitation of numerical ranges by endpoints includes all numbers subsumed within the range (e.g. the range 1 to 10 includes 1, 1.5, 3.33, and 10).

Unless otherwise indicated, all numbers expressing quantities of ingredients, measurements of properties, and so like as used in the specification and claims are to be understood to be modified in all instances by the term “about.” (“Meth)acryl” refers to functional groups including acrylates, methacrylates, acrylamide, and methacrylamide.

“(Meth)acrylate” refers to both acrylate and methacrylate compounds.

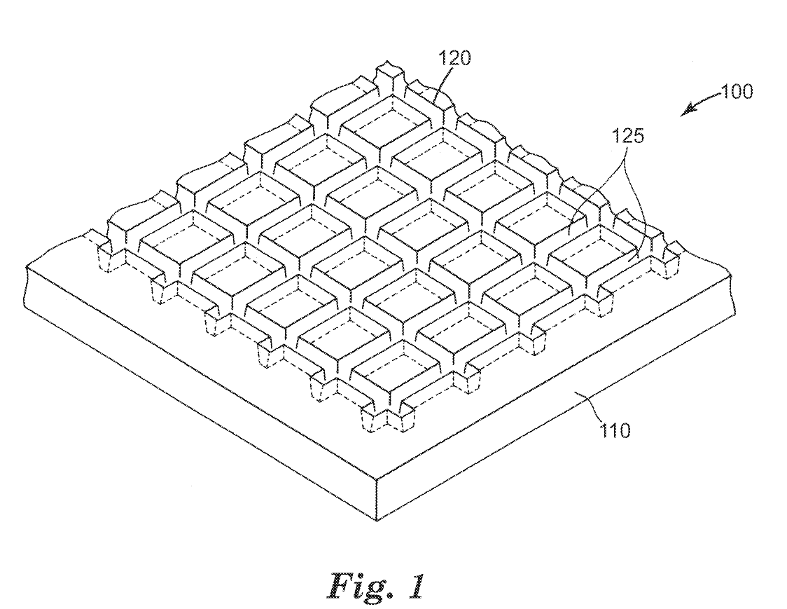

FIG. 1 is a partial perspective view showing an illustrative (e.g. flexible) mold 100. The flexible mold 100 generally has a two-layered structure having a planar support layer 110 and a microstructured surface, referred to herein as a shape-imparting layer 120 provided on the support. The flexible mold 100 of FIG. 1 is suitable for producing a grid-like rib pattern (also referred to as a lattice pattern) of barrier ribs on a (e.g. electrode patterned) back panel of a plasma display panel. Another common barrier ribs pattern (not shown) comprises plurality of (non-intersecting) ribs arranged in parallel with each other, also referred to as a linear pattern.

The flexible mold is typically prepared from a transfer mold, having a corresponding inverse microstructured surface pattern as the flexible mold. The transfer mold may have a microstructured surface comprised of a cured (e.g. silicone rubber) polymeric material, such as described in U.S. application Ser. No. 11/030,261 filed Jan. 6, 2005.

Although the support 110 may optionally comprise the same material as the shape-imparting layer for example by coating the polymerizable composition onto the transfer mold in an amount in excess of the amount needed to only fill the recesses, the support is typically a preformed polymeric film. The thickness of the polymeric support film is typically at least 0.025 millimeters, and typically at least 0.075 millimeters. Further the thickness of the polymeric support film is generally less than 0.5 millimeters and typically less than 0.300 millimeters. The tensile strength of the polymeric support film is generally at least about 5 kg/mm² and typically at least about 10 kg/mm². The polymeric support film typically has a glass transition temperature (Tg) of about 60° C. to about 200° C. Various materials can be used for the support of the flexible mold including cellulose acetate butyrate, cellulose acetate propionate, polyether sulfone, polymethyl methacrylate, polyurethane, polyester, and polyvinyl chloride. The surface of the support may be treated to promote adhesion to the polymerizable resin composition. Examples of suitable polyester based materials include photograde polyethylene terephthalate and polyethylene terephthalate (PET) having a surface that is formed according to the method described in U.S. Pat. No. 4,340,276.

The depth, pitch and width of the microstructures of the shape-imparting layer can vary depending on the desired finished article. The depth of the microstructured (e.g. groove) pattern 125 (corresponding to the barrier rib height) is generally at least 100 μm and typically at least 150 μm. Further, the depth is typically no greater than 500 μm and typically less than 300 μm. The pitch of the microstructured (e.g. groove) pattern may be different in the longitudinal direction in comparison to the transverse direction. The pitch is generally at least 100 μm and typically at least 200 μm. The pitch is typically no greater than 600 μm and typically less than 400 μm. The width of the microstructured (e.g. groove) pattern 4 may be different between the upper surface and the lower surface, particularly when the barrier ribs thus formed are tapered. The width is generally at least 10 μm, and typically at least 50 μm. Further, the width is generally no greater than 100 μm and typically less than 80 μm. For lattice pattern embodiments, the width of the grooves may be different in the longitudinal and transverse directions.

The thickness of an illustrative shape-imparting layer is generally at least 5 μm, typically at least 10 μm, and more typically at least 50 μm. Further, the thickness of the shape-imparting layer is generally no greater than 1,000 μm, typically less than 800 μm and more typically less than 700 μm. When the thickness of the shape-imparting layer is below 5 μm, the desired rib height for many PDP panels cannot be obtained. However, such thicknesses may be acceptable for making other types of microstructures. When the thickness of the shape-imparting layer is greater than 1,000 μm, warp and reduction of dimensional accuracy of the mold can result due to excessive shrinkage.

Flexible mold 100, can be used to produce (e.g. barrier rib) microstructures on a substrate such as a (e.g. plasma) display panel. Prior to use, the flexible mold or components thereof may be conditioned in a humidity and temperature controlled chamber (e.g. 22° C./55% relative humidity) to minimize the occurrence of dimensional changes during use. Such conditioning of the flexible mold is described in further detail in WO2004/010452; WO2004/043664 and JP Application No. 2004-108999, filed Apr. 1, 2004.

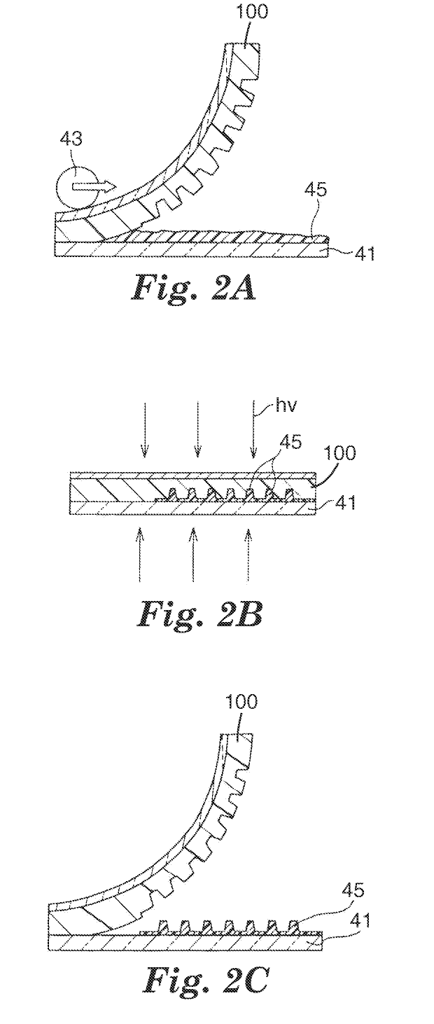

With reference to FIG. 2A, a flat transparent (e.g. glass) substrate 41, having an (e.g. striped) electrode pattern is provided. The flexible mold 100 of the invention is positioned for example by use of a sensor such as a charge coupled device camera, such that the barrier pattern of the mold is aligned with the electrode pattern of the substrate. A barrier rib precursor 45 such as a curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. As depicted in FIG. 2A, a (e.g. rubber) roller 43 may be employed to engage the flexible mold 100 with the barrier rib precursor. The rib precursor 45 spreads between the glass substrate 41 and the shape-imparting surface of the mold 100 filling the groove portions of the mold. In other words, the rib precursor 45 sequentially replaces air of the groove portions. Subsequently, the rib precursor is cured. The rib precursor is preferably cured by radiation exposure to (e.g. UV) light rays through the transparent substrate 41 and/or through the mold 100 as depicted on FIG. 2B. As shown in FIG. 2C, the flexible mold 100 is removed while the resulting cured ribs 48 remain bonded to the substrate 41.

Although the mold may comprise other (e.g. cured) polymeric materials, at least the (e.g. microstructured surface) molding surface of the mold comprises the photopolymerized reaction product of a polymerizable composition generally comprising at least one ethylenically unsaturated oligomer and at least one ethylenically unsaturated diluent. The ethylenically unsaturated diluent is copolymerizable with the ethylenically unsaturated oligomer. The oligomer generally has a weight average molecular weight (Mw) as determined by Gel Permeation Chromatography (described in greater detail in the example) of at least 1,000 g/mole and typically less than 50,000 g/mole. The ethylenically unsaturated diluent generally has a Mw of less than 1,000 g/mole and more typically less than 800 g/mole.

The oligomer and monomer have functionality that react (e.g. crosslink) upon exposure to light. Representative examples of photopolymerzable groups include epoxy groups, (meth)acrylate groups, olefinic carbon-carbon double bonds, allyloxy groups, alpha-methyl styrene groups, (meth)acrylamide groups, cyanate ester groups, vinyl ethers groups, combinations of these, and the like. Free radically polymerizable groups are preferred. Of these, (meth)acryl functionality is typical and (meth)acrylate functionality more typical. Typically at least one of the ingredients of the polymerizable composition, and most typically the oligomer, comprises at least two (meth)acryl groups.

Various known oligomers having (meth)acryl functional groups can be employed. Suitable oligomers include (meth)acrylated urethanes (i.e., urethane (meth)acrylates), (meth)acrylated epoxies (i.e., epoxy(meth)acrylates), (meth)acrylated polyesters (i.e., polyester (meth)acrylates), (meth)acrylated (meth)acrylics, (meth)acrylated polyethers (i.e., polyether (meth)acrylates) and (meth)acrylated polyolefins. The oligomer(s) and monomer(s) preferably have a glass transition temperature (Tg) of about −80° C. to about 60° C., respectively, meaning that the homopolymers thereof have such glass transition temperatures.

The oligomer is generally combined with the monomer in amounts of 5 wt-% to 90 wt-% of the total polymerizable composition of the mold. Typically, the amount of oligomer is at least 20 wt-%, more typically at least 30 wt-%, and more typically at least 40 wt-%. In at least some preferred embodiments, the amount of oligomer is at least 50 wt-%, 60 wt-%, 70 wt-%, or 80 wt-%.

In some embodiments, the polymerizable composition of the flexible mold may comprise one or more urethane (meth)acrylate oligomers such as commercially available from Daicel-UCB Co., Ltd. under the trade designation “EB 270” and “EB 8402”. In other embodiments, the polymerizable composition of the flexible mold may comprise one or more polyolefin (meth)acrylate oligomers such as commercially available from Osaka Organic Chemical Industry Ltd., under the trade designation “SPDBA”. Other suitable flexible mold compositions are known.

Various (meth)acryl monomers are known including for example aromatic (meth)acrylates including phenoxyethylacrylate, phenoxyethyl polyethylene glycol acrylate, nonylphenoxy polyethylene glycol, 3-hydroxyl-3-phenoxypropyl acrylate and (meth)acrylates of ethylene oxide modified bisphenol; hydroxyalkyl(meth)acrylates such as 4-hydroxybutylacrylate; alkylene glycol (meth)acrylates and alkoxy alkylene glycol (meth)acrylates such as methoxy polyethylene glycol monoacrylate and polypropylene glycol diacrylate; polycaprolactone (meth)acrylates; alkyl carbitol (meth)acrylates such as ethylcarbitol acrylate and 2-ethylhexylcarbitol acrylate; as well as various multifunctional (meth)acryl monomers including 2-butyl-2-ethyl-1,3-propanediol diacrylate and trimethylolpropane tri(meth)acrylate.

Preferred polymerizable compositions for use in making the flexible mold are described in pending U.S. patent application Ser. No. 11/107,554 filed Apr. 15, 2005.

Presently described is a microstructured mold prepared from a photocured polymeric material that comprises at least one (i.e. first) photoinitiator having certain absorption characteristics. The mold is suitable for use in methods of molding a (e.g. barrier rib) microstructure precursor composition that comprises at least one (i.e. second) photoinitiator. The second photoinitiator of the microstructure precursor preferably has similar absorptions characteristics as the first photoinitiator. Thus, the polymeric material of the mold the microstructure precursor can be cured with the same wavelength range of light.

A good, basic discussion of how photoinitiators work is given in “Photoinitiators: Mechanism and Applications”, by C—H, Chang, A. Mar, A. Tiefenthaler, and D. Wostratzky, in Handbook of Coatings Additives, Vol. 2, L. J. Calbo, Ed, Marcel Dekker, Inc., 1992. Photoinitiators useful in this invention act by absorbing light and undergoing some kind of chemical change to generate a free radical, which initiates acrylate polymerization.

Absorption spectra of various photoinitiators are typically reported by the suppliers. Alternatively, the spectrum of a photoinitiator can be measured with standard photometric techniques. The absorbance of a photoinitiator solution at any wavelength may be expressed as:

Absorbance=A=ε*C*L

where ε is the molar absorptivity at the wavelength and is expressed in units of liters/mole/centimeter;

### C is the concentration of the photoinitiator in a particular solvent in moles per liter; and

### L is the path length of the sample in centimeters.

The molar absorptivity of a useful photoinitiator is typically at least 100 at one or more wavelengths within the wavelength range employed to cure the (e.g. rib precursor) composition. In one embodiment, the photocured polymeric composition for use in making the mold comprises at least one photoinitiator that has a molar absorptivity, also known as an absorption coefficient, of at least 100 at wavelengths of about 380 nm or greater. More typically the absorption coefficient is at least 100 for a wavelength span of about 25 nm to 50 nm, such span being within the wavelength range employed to cure the rib precursor. The absorption coefficient may be about 200 or greater at wavelengths ranging from about 340 nm to about 400 nm. In some embodiments, the absorption coefficient may be about 200 or greater at wavelengths up to about 420 nm.

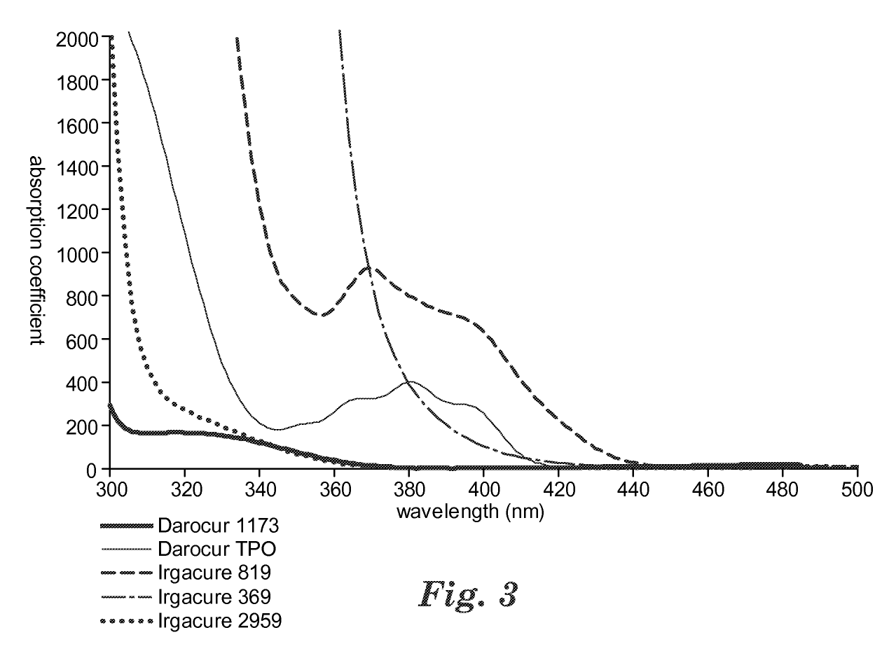

With reference to FIG. 3, although photoinitiators available from Ciba Specialty Chemicals under the trade designations “Darocur 1173” and “Irgacure 2959” do not exhibit such characteristics, photoinitiators that exhibit the absorption spectra characteristics just described are set forth in the following Table 1.

TABLE 1
Photoinitiator for Ultraviolet Curing

| | | | | UV/VIS |
|---|---|---|---|---|
| | | | | Absorption |
| Trade | | Chemical | Melting | Peaks (nm) in |
| Designation | Chemical Class | Description | Point | methanol |
| “Irgacure 819” | bis acyl | phenyl bis (2,4,6- | 127–133° C. | 370, 405 |
| from Ciba | phosphine oxide | trimethyl | | |
| Specialty | | benzoyl)- | | |
| Chemicals | | phosphine oxide | | |
| “Irgacure 369” | α-aminoketone | 2-benzyl-2- | 110–114° C. | 233, 324 |
| from Ciba | | (dimethylamino)- | | |
| Specialty | | 1-[4-(4- | | |
| Chemicals | | morpholinyl) | | |
| | | phenyl]-1-butanone | | |

Thus, acyl phosphine oxide and α-amino ketone photoinitiators are activated and cleave forming sufficient free radicals at wavelengths greater than about 380 nm and thus are suitable photoinitiators for curing with super actinic bulbs that provide spectra emissions from about 385 nm to 465 nm with a peak at 420 nm. Other photoinitiators and photoinitiator combinations having similar UV absorption characteristics to that of acyl phosphine oxide and α-aminoketone may also suitably be employed as may be determined by one of ordinary skill in the art.

In another embodiment, the method of making a microstructured article employs providing a mold wherein at least the microstructured surface of the mold comprises a polymeric material photocured at a wavelength ranging from about 385 nm to 465 nm; filling at least the recesses of the mold with a photocurable microstructure precursor composition; and photocuring the microstructure precursor at a wavelength range that includes at least a portion of the wavelength range employed to photocure the polymeric material of the mold. As exemplified in the forthcoming examples, once the microstructure precursor is cured, the mold can be removed without breakage of the cured (e.g. barrier rib) microstructures.

The polymerizable compositions for use in making the flexible mold comprise at least one photoinitiator that exhibits appreciable absorbance in the same wavelength range as the photointiator employed for curing the rib precursor. Accordingly, the photocured mold comprises a photoinitiator having similar absorbance characteristics to that of the photoinitiator of the rib precursor composition, as can be provided by photoinitiators such as acyl phosphine oxides and α-amino ketones.

The part of the photoinitiator molecule which absorbs the light is called the chromophore. When the chemical change leading to radical production involves significant disruption of the chromophore, such as alpha cleavage, usually that change causes the absorption band of the remaining part of the chromophore to move to shorter wavelengths. This phenomenon can be called “photobleaching”. Photobleaching is a relatively strong effect in such initiators as acyl phosphine oxides (e.g. “Darocur TPO”) and α-amino ketones (e.g. “Irgacure 369”). However, photobleaching is a relatively weak effect in α-hydroxyketones, such as “Darocur 1173” and Irgacure 2959”.

A single photoinitiator or blends thereof may be employed. In general the photoinitiator(s) are at least partially soluble (e.g. at the processing temperature of the resin). The amount of photoinitiator is typically at least about 0.5 wt-%, (e.g. 0.6 wt-%, 0.7 wt-%, 0.8 wt-%, (0.9 wt-%) and more typically about 1.0 wt-%. Greater than 5 wt-% photoinitiator is generally disadvantageous in view of the tendency to reduce the depth of cure. Typically, the concentration of photoinitiator is no more than about 3.0 wt-%.

These particular kinds and amounts of photoinitiator can result in higher conversion of monomeric components to polymeric components. The conversion can be determined with infrared spectroscopy as described in further detail in the subsequently described test methods. Higher conversion is indicative of a reduction in residual monomer. Higher conversion is surmised to be amenable to other improved properties such as increased hardness.

The photocurable barrier rib precursor (also referred to as “slurry” or “paste”) comprises at least three components in addition to the photoinitiator just described. However, for other type of microstructures, the photocurable composition provided in the recesses of the mold may comprise photocurable oligomer and/or monomer in the absence of an inorganic particulate.

The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening. The rib precursor composition preferably has a viscosity of less than 20,000 cps and more preferably less than 10,000 cps to uniformly fill all the microstructured groove portions of the flexible mold without entrapping air. The rib precursor composition preferably has a viscosity of between about 20 to 600 Pa—S at a shear rate of 0.1/sec and between 1 to 20 Pa—S at a shear rate of 100/sec.

Various curable organic binders can be employed. The curable organic binder is curable for example by exposure to radiation or heat. The binder may comprise monomers and oligomers in any combination, so long as the mixture with inorganic particulate material has a suitable viscosity. It is typically preferred that the binder is radiation curable under isothermal conditions (i.e. no change in temperature). This reduces the risk of shifting or expansion due to differential thermal expansion characteristics of the mold and the substrate, so that precise placement and alignment of the mold can be maintained as the rib precursor is hardened.

The diluent is not simply a solvent compound for the resin. The diluent is preferably soluble enough to be incorporated into the resin mixture in the uncured state. Upon curing of the binder of the slurry, the diluent should phase separate from the monomers and/or oligomers participating in the cross-linking process. Preferably, the diluent phase separates to form discrete pockets of liquid material in a continuous matrix of cured resin, with the cured resin binding the particles of the glass frit or ceramic powder of the slurry. In this way, the physical integrity of the cured green state microstructures is not greatly compromised even when appreciably high levels of diluent are used (i.e., greater than about a 1:3 diluent to resin ratio). This provides two advantages. First, by remaining a liquid when the binder is hardened, the diluent reduces the risk of the cured binder material adhering to the mold. Second, by remaining a liquid when the binder is hardened, the diluent phase separates from the binder material, thereby forming an interpenetrating network of small pockets, or droplets, of diluent dispersed throughout the cured binder matrix which facilitates the debinding process.

Optionally, the photocurable rib precursor compositions may comprise a dispersant and/or a thixotropic agent. Each of these additives may be employed in amounts from about 0.05 to 2.0 wt-% of the total rib precursor composition. Typically, the amount of each of these additives is no greater than about 0.5 wt-%. Further, the rib precursor may comprise an adhesion promoter such as a silane coupling agent to promote adhesion to the substrate (e.g. glass panel of PDP). The rib precursor may also optionally comprise various additives including but not limited to surfactants, catalysts, etc. as known in the art.

In general, inorganic thixotropes may comprise clays (e.g. bentonite), silica, mica, smectite and others, having particles sizes of less than 0.1 μm. In general, organic thixotropes may comprise fatty acids, fatty acid amines, hydrogenated castor oil, casin, glue, gelatin, gluten, soybean protein, ammonium alginate, potassium alginate, sodium alginate, gum arabic, guar gum, soybean lecithin, pectin acid, starch, agar, polyacrylic acid ammonium, sodium polyacrylate, ammonium polymethacrylate, potassium salt, (e.g. modified acrylic polymers and copolymers, polyhydroxycarboxylic acid amines and amides (such as available from BYK-Chemie Co. under the trade designation “BYK 405”), polyvinyl alcohol, vinyl polymer (vinyl methyl ether/maleic anhydride), vinyl pyrrolidone copolymer, polyacrylamide, fatty acid amide or other aliphatic amide compound, carboxylated methylcellulose, hydroxymethycellulose, hydroxyethylcellulose, xanthic acid cellulose, carboxylated starch, urea urethane, oleic acid, and sodium silicate.

In some aspects, the dispersant is a basic polymer, i.e. a homopolymer, oligomer, or copolymer of at least one moderately to strongly polar Lewis base-functional copolymerizable monomer. Polarity (e.g. hydrogen or ionic bonding ability) is frequently described by the use of terms such as “strongly”, “moderately” and, “poorly”. References describing these and other solubility terms include “Solvents paint testing manual”, 3rd ea., G. G. Seward, Ed., American Society for Testing and Materials, Philadelphia, Pa., and “A three-dimensional approach to solubility”, Journal of Paint Technology, Vol. 38, No. 496, pp. 269-280. Various basic polymer dispersants are known such as an anionic polyamide based polymeric dispersant commercially available from Ajinomoto-Fine-Techno Co. under the trade designation “Ajisper PB 821”.

In other embodiments, an acidic polymer may be employed as a dispersant. For example, the rib precursor may comprise 0.1 to 1 parts by weight of a phosphorus-based compound having at least one phosphorus-acid group alone or in combination with 0.1 to 1 parts by weight of a sulfonates based compound. Such compounds are described in WO2005/019934. Other acidic compounds for use as dispersants are commercially available such as from Noveon under the trade designation “SolPlus D520”.

The amount of curable organic binder in the rib precursor composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

The paste can be prepared by conventional mixing techniques. For example, the glass- or ceramic-forming particulate material (e.g. powder) can be combined with diluent and dispersant at a ratio of about 10 to 15 parts by weight of diluent; followed by the addition of the remainder of the paste ingredients. The paste is typically filtered to 5 microns.

In preferred embodiments, the flexible mold or the transfer mold from which the flexible mold is made from can be reused as described in FN60456 and 60736; incorporated herein by reference.

For embodiments wherein the rib precursor is cured through the flexible mold, the flexible mold is suitable for reuse when the flexible mold is sufficiently transparent. A sufficiently transparent flexible mold typically has a haze (as measured according to the test method described in the examples) of less than 15%, preferably of less than 10% and more preferably no greater than 5% after a single use. Even more preferably, the flexible mold has the haze criteria just described after being reused at least 5 times. An increase in haze of the mold is evidence of paste sticking and building up on the mold. This buildup can cause bad fidelity of molded structures or bad surface finish.

In preferred embodiments, the rib precursor comprises a diluent having a solubility parameter that is less than the curable organic binder.

The solubility parameter of various monomers, δ(delta), can conveniently be calculated using the expression:

δ=(ΔEv/V)^{1/2},

where ΔEv is the energy of vaporization at a given temperature and V is the corresponding molar volume. According to Fedors' method, the SP can be calculated with the chemical structure (R. F. Fedors, Polym. Eng. Sci., 14(2), p. 147, 1974, Polymer Handbook 4^{th} Edition “Solubility Parameter Values” edited by J. Brandrup, E. H. Immergut and E. A. Grulke).

The difference between the solubility parameter of the curable binder and the diluent is at least 1 [MJ/m³]^{1/2} and typically at least 2 [MJ/m³]^{1/2}. The difference between the solubility parameter of the curable binder and the diluent is preferably at least 3 [MJ/m³]^{1/2}, 4 [MJ/m³]^{1/2}, or 5 [MJ/m³]^{1/2}. The difference between the solubility parameter of the curable binder and the diluent is more preferably at least 6 [MJ/m³]^{1/2}, 7 [MJ/m³]^{1/2}, or 8 [MJ/m³]^{1/2}.

Various organic diluents can be employed depending on the choice of curable organic binder. In general suitable diluents include various alcohols and glycols such as alkylene glycol (e.g. ethylene glycol, propylene glycol, tripropylene glycol), alkyl diol (e.g. 1, 3 butanediol,), and alkoxy alcohol (e.g. 2-hexyloxyethanol, 2-(2-hexyloxy)ethanol, 2-ethylhexyloxyethanol); ethers such as dialkylene glycol alkyl ethers (e.g. diethylene glycol monoethyl ether, dipropylene glycol monopropyl ether, tripropylene glycol monomethyl ether); esters such as lactates and acetates and in particular dialkyl glycol alkyl ether acetates (e.g. diethylene glycol monoethyl ether acetate); alkyl succinate (e.g. diethyl succinate), alkyl glutarate (e.g. diethyle glutarate), and alkyl adipate (e.g. diethyl adipate).

The glass- or ceramic-forming particulate material (e.g. powder) is chosen based on the end application of the microstructures and the properties of the substrate to which the microstructures will be adhered. One consideration is the coefficient of thermal expansion (CTE) of the substrate material (e.g. glass panel of PDP). Preferably, the CTE of the glass- or ceramic-forming material of the slurry of the present invention differs from the CTE of the substrate material (e.g. electrode patterned glass panel of a PDP) by no more than 10%. When the substrate material has a CTE which is much less than or much greater than the CTE of the ceramic material of the microstructures, the microstructures can warp, crack, fracture, shift position, or completely break off from the substrate during processing. Further, the substrate can warp due to a high difference in CTE between the substrate and the fired microstructures. Inorganic particulate materials suitable for use in the slurry of the present invention when making PDP barrier ribs preferably have coefficients of thermal expansion of about 5×10⁻⁶/° C. to 13×10⁻⁶/° C.

Glass and/or ceramic materials suitable for use in the slurry of the present invention typically have softening temperatures below about 600° C., and usually above 400° C. The softening temperature of the ceramic powder indicates a temperature that must be attained to fuse or sinter the material of the powder. The substrate generally has a softening temperature that is higher than that of the ceramic material of the rib precursor. Choosing a glass and/or ceramic powder having a low softening temperature allows the use of a substrate also having a relatively low softening temperature.

Suitable composition include for example i) ZnO and B₂O₃; ii) BaO and B₂O₃; iii) ZnO, BaO, and B₂O₃; iv) La₂O₃ and B₂O₃; and v) Al₂O₃, ZnO, and P₂O₅. Lower softening temperature ceramic materials can be obtained by incorporating certain amounts of lead, bismuth, or phosporous into the material. Other low softening temperature ceramic materials are known in the art. Other fully soluble, insoluble, or partially soluble components can be incorporated into the ceramic material of the slurry to attain or modify various properties.

As described in U.S. Pat. No. 6,802,754, the selection of a photoinitiator can depend on what materials are used for the ceramic powder in the slurry used in the present invention. For example, in applications where it is desirable to form ceramic microstructures which are opaque and highly diffusely reflective, it can be advantageous to include a certain amount of titania (TiO₂) in the ceramic powder of the slurry. While titania can be useful for increasing the reflectivity of the microstructures, it can also make curing with visible light difficult because visible light reflection by the titania in the slurry can prevent sufficient absorption of the light by the cure initiator to effectively cure the binder. However, by selecting a cure initiator which is activated by radiation which can simultaneously propagate through the substrate and the titania particles, effective curing of the binder can take place. The photoinitiators described herein are active in the blue region of the visible spectrum near the edge of the ultraviolet in a relatively narrow region where the radiation can penetrate both a glass substrate and titania particles in the slurry. Other cure systems may be selected for use in the process of the present invention based on the binder, the materials of the ceramic powder in the slurry, and the material of the mold or the substrate through which curing is to take place.

The preferred size of the particulate glass- or ceramic-forming material of the rib precursor depends on the size of the microstructures to be formed and aligned on the patterned substrate. The average size, or diameter, of the particles is typically no larger than about 10% to 15% the size of the smallest characteristic dimension of interest of the microstructures to be formed and aligned. For example, the average particle size for PDP barrier ribs is typically no larger than about 2 or 3 microns.

Various other aspects that may be utilized in the invention described herein are known in the art including, but not limited to each of the following patents: U.S. Pat. No. 6,247,986; U.S. Pat. No. 6,537,645; U.S. Pat. No. 6,352,763; U.S. Pat. No. 6,843,952, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; WO2005/042427; WO2005/019934; WO2005/021260; and WO2005/013308.

The present invention is illustrated by the following non-limiting examples.

### EXAMPLES

### Ingredients Employed in the Examples:

### Urethane (meth)acrylate oligomers available from Cytec Surface Specialties, Smyrna, Ga. under the trade designation “EB8402”

### Caprolactone acrylate monomer available from Sartomer, Exton, Pa., under the trade designation “SR495”.

### Epoxy(meth)acrylate oligomer commercially available from Kyoeisya Chemical Co., Ltd., under the trade designation 80-MFA.

### Dispersant available from Kyoeisha, Tokyo, JP, under the trade designation “DOPA-33”.

### Dipropylene glycol propyl ether available from Aldrich, Milwaukee, Wis.

### Thixotrope available from BYK Chemie, Wesel, Germany, under the trade designation “BYK-405”.

### Dispersant available from Noveon, Inc., Cleveland, Ohio, under the trade designation “Solplus D-520”.

Photopolymerizable resin compositions having various photoinitiators were prepared to evaluate the suitability of such resins for use in making a flexible mold. Suitable resin candidates were also evaluated to determine the suitability of such cured resin to be employed as the flexible mold for photopolymerizing barrier rib precursor compositions.

### Comparative Example A

A polymerizable resin composition (EB8402/SR495 90 wt-%/10 wt-%, and 1 wt-% of a 2-hydroxy-1-[4-(hydroxyl-ethoxy)phenyl]-2-methyl-1-propanone photoinitiator commercially available from Ciba Specialty Chemicals under the trade designation “Irgacure 2959” was prepared. The resin was coated at a thickness of 100 microns between two 50 micron thick polyester sheets. The assembly of resin between the polyester sheets was photocured with a bank of 10 “Super Actinic” bulbs (Philips TLDK 30W/03, with emission from about 385-465 nm and peak emission at 420 nm) for 3 minutes. The polymerizable resin composition was still completely fluid, with no evidence of cure.

### Example 1

A polymerizable resin was prepared consisting of EB8402 (90 wt-%) and SR495 (10 wt-%) with 1 wt-% of Darocur TPO added. A 100 micron thick flat film of this resin was cured between polyester sheets for 6 minutes with the super actinic bulbs, and the absorption was monitored at 380 nm. The absorption decreased from 0.2234 to 0.0624 over the exposure time. The resulting polymer film was flexible but not tacky. One polyester film was peeled off to give a cured resin/polyester sample.

A barrier rib precursor composition was prepared by combining glass frit (containing SiO₂—PbO—B₂O₃ with added TiO₂ (168 g) available as RFW401C2 from Asahi Glass Co., Ltd, Japan), 80MFA oligomer (21 g), dipropyleneglycol propyl ether (21 g), SolPlus D520 (dispersant, 2.016 g), and Darocur TPO (0.294 g) photoinitiator. The rib precursor was coated at 100 microns between polyester and the cured resin of the cured resin/polyester sample just described. This sandwich was cured by irradiating through the polyester/cured resin with the super actinic bulbs. After only 30 sec. both top and bottom of the paste were cured and dry. The cured resin and cured paste were easily separated with no residue visible on the cured resin.

### Example 2

Example 1 was repeated, except that Irgacure 369 was used in the paste instead of Darocur TPO. After irradiating the paste through the cured resin/polyester side for 30 seconds, the paste was cured hard and dry. By peeling the resin/polyester sample back at a sharp angle, it could be removed from the cured paste with no visible residue of paste on the resin surface.

### Example 3

Example 2 was repeated, except that blacklight bulbs (Philips TLD15W/08) with a spectra emission from about 340-410 nm and peak emission at 365 nm) were used to cure the polymerizable mold resin. The final result was the same, i.e. the paste was well-cured and released cleanly from the cured mold resin.

What is claimed is:

1. A method of making barrier ribs comprising:
providing a mold having a microstructured surface comprising recesses suitable for making barrier ribs wherein at least the microstructured surface comprises a photocured polymeric material comprising a first photoinitiator having an absorption coefficient of at least 100 at a wavelength ranging from about 385 nm to about 465 nm;
filling the recesses of the mold with a photocurable rib precursor comprising an oligomer, a diluent, an inorganic particulate, and a second photoinitiator;
photocuring the rib precursor; and
removing the mold from the cured barrier ribs.

2. The method of claim 1 wherein prior to curing the rib precursor is contacted with a substrate.

3. The method of claim 2 wherein the substrate is a glass substrate having an electrode pattern and the microstructured surface of the mold is aligned with the electrode pattern.

4. The method of claim 2 wherein rib precursor is photocured through the mold, through the substrate, or a combination thereof.

5. The method of claim 1 wherein the second photoinitiator has an absorption coefficient of at least 100 at a wavelength ranging from about 385 nm to about 465 nm.

6. The method of claim 1 wherein the first photoinitiator is selected from acyl phosphine oxide, α-aminoketone, and mixtures thereof.

7. The method of claim 1 wherein the rib precursor comprises a second photoinitiator selected from acyl phosphine oxide, α-aminoketone, and mixtures thereof.

8. The method of claim 1 wherein the first and second photoinitiator are selected from acyl phosphine oxide, α-aminoketone, and mixtures thereof.

9. The method of claim 1 wherein the photocuring light is provided by super actinic bulbs.

10. The method of claim 1 wherein the mold further comprises a light transmissible support.

11. The method of claim 10 wherein the support is a polyester film.

12. A mold having a microstructured surface comprising recesses wherein the microstructured surface comprises a photocured polymeric material comprising a photoinitiator having an absorption coefficient of at least 100 at a wavelength ranging from about 385 nm to about 465 nm.

13. An intermediate assembly prepared during a method of making a microstructured article comprising:
the mold of claim 12; and
a photocurable microstructure precursor composition comprising a second photoinitiator provided in at least the recesses of the microstructured surface.

14. The intermediate assembly of claim 13 wherein the photocurable microstructure precursor composition comprises an oligomer, a diluent, and an inorganic particulate.

15. The intermediate assembly of claim 13 wherein the second photoinitiator has an absorption coefficient of at least 100 at a wavelength ranging from about 385 nm to about 465 nm.

16. A method of making microstructures comprising:
providing a mold having a microstructured surface comprising recesses wherein at least the microstructured surface comprises a photocured polymeric material comprising a first photoinitiator having an absorption coefficient of at least 100 at a wavelength ranging from about 385 nm to about 465 nm;
filling the recesses of the mold with a photocurable microstructure precursor;
photocuring the microstructure precursor; and
removing the mold from the cured microstructures.

17. The method of claim 16 wherein the microstructure precursor composition is substantially free of inorganic material.

18. A method of making a microstructured article comprising:
providing a mold having a microstructured surface comprising recesses wherein at least the microstructured surface comprises a photocured polymeric material having a first photoinitiator selected from acyl phosphine oxide, α-amino ketone, and mixtures thereof, filling the recesses of the mold with a photocurable microstructure precursor comprising a second photoinitiator selected from acyl phosphine oxide, α-amino ketone, and mixtures thereof;
photocuring the microstructure precursor; and
removing the mold.

19. The method of claim 18 wherein the mold is suitable for making barrier ribs.

20. The method of claim 18 wherein the photocurable microstructure precursor comprises an oligomer, a diluent, and an inorganic particulate.

21. The method of claim 18 wherein prior to curing the microstructure precursor is contacted with a glass substrate having an electrode pattern and the microstructured surface of the mold is aligned with the electrode pattern.

22. A method of making a microstructured article comprising:
providing a mold having a microstructured surface comprising recesses wherein at least the microstructured surface comprises a polymeric material photocured at a wavelength ranging from about 385 nm to 465 nm;
filling the recesses of the mold with a microstructure precursor composition comprising a second photoinitiator;
photocuring the microstructure precursor composition at a wavelength range that includes at least a portion of the wavelength range used to cure the photocured polymeric material of the mold; and
removing the mold from the cured microstructures without breakage of the microstructures.

23. The method of claim 22 wherein prior to curing the microstructure precursor is contacted with a glass substrate having an electrode pattern and the microstructured surface of the mold is aligned with the electrode pattern.
